(19) United States
(12) Patent Application Publication
(10) Pub. No.: US 2026/0259991 A1
(43) Pub. Date: Sep. 3, 2026

(54) LOW-INTERVENTION SECURITY TESTING OF APPLICATIONS LEVERAGING LANGUAGE MODELS WITH DEPLOYMENT ENVIRONMENT REPLICATION

(71) Applicant: Palo Alto Networks, Inc., Santa Clara, CA (US)

(72) Inventors: Jay Chien An Chen, Fairfax, VA (US); Chien-Hua Lu, San Jose, CA (US); Bo Qu, Saratoga, CA (US); Wenjun Hu, Santa Clara, CA (US); Ali Islam, Fremont, CA (US); Mei Wang, Saratoga, CA (US)

(21) Appl. No.: 19/067,371

(22) Filed: Feb. 28, 2025

(51) Int. Cl. G06F 21/57; G06F 21/55

(52) U.S. Cl. CPC G06F 21/577; G06F 21/552

(57) ABSTRACT

A testing environment provisioning service obtains configuration information for an AI application based on monitoring its deployment environment to determine an initial configuration thereof. Configuration information included in the initial configuration includes configuration information for the language model(s) used by the AI application, a prompt template(s) used by the AI application, and a configuration of a content filter that interfaces with the language model(s). The service monitors the deployment environment for changes to this initial configuration by periodically obtaining additional configuration information for the deployment environment and evaluating the additional configuration information against initial configuration. When a substantial change to the initial configuration is detected, the testing service updates the initial configuration and provisions a testing environment with a language model(s) and any content filter configured according to the updated configuration. Security testing to identify prompt injection or jailbreaking affecting the AI application is initiated in the testing environment.

### BACKGROUND

The disclosure generally relates to data processing (e.g., CPC subclass G06F) and to computing arrangements based on specific computational models (e.g., CPC subclass G06N).

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the “Transformer” architecture. A “Transformer” was introduced in VASWANI, et al. “Attention is all you need” presented in Proceedings of the 31st International Conference on Neural Information Processing Systems in December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data. Some LLMs are based on the Transformer architecture. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks.

User-facing language models pose unique security risks. Prompt injection attacks occur when prompts are manipulated to thereby generate unintended or harmful outputs by a foundation model. Attacks can also be multi-turn, such as payload splitting and Crescendo attacks, exploiting the model's memory of prior context to trigger undesired actions in subsequent interactions. Attacks designed to bypass the guardrails that provide measures for controlling behaviors of language models, whether single-turn or multi-turn, are sometimes termed “jailbreak attacks” or simply “jailbreaks.” Successful attacks can lead to the leakage of sensitive information, unauthorized access to systems, or the generation of deceptive content.

### BRIEF DESCRIPTION OF THE DRAWINGS

Embodiments of the disclosure may be better understood by referencing the accompanying drawings.

FIG. 1 is a conceptual diagram of generating a baseline configuration for a deployment environment of an AI application.

FIG. 2 is a conceptual diagram of provisioning a testing environment for security testing for an AI application based on detecting a change to a baseline configuration of a deployment environment of the AI application.

FIG. 3 is a flowchart of example operations for determining an initial configuration of a deployment environment of an AI application.

FIG. 4 is a flowchart of example operations for monitoring a deployment environment of an AI application for changes to an initial configuration.

FIG. 5 is a flowchart of example operations for provisioning a testing environment according to an updated configuration of a deployment environment of an AI application.

FIG. 6 is a flowchart of example operations for validating a testing environment provisioned based on an updated configuration of a deployment environment of an AI application.

FIG. 7 is a flowchart of example operations for reconstructing a prompt template used by an AI application based on sample prompt-response pairs.

FIG. 8 depicts an example computer system with a testing environment provisioning service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Penetration testing, such as with red teaming, is a common approach for performing security testing of applications that leverage language models (“artificial intelligence (AI) applications”) to identify security issues with the AI-related components used by the AI application (i.e., the language model(s) and content filter(s), if any), such as jailbreaking attacks or prompt injection. However, AI applications may change in deployment, whether due to changes in the AI application itself (e.g., updates/changes to prompt templates used by the AI application), changes to the language model(s) that it leverages, or changes in other components leveraged by the AI application for interfacing with the language model(s), such as content filters. Penetration testing results generated from testing the AI application thus become outdated in the event of such a change. Additionally, the direct interaction with an AI application performed as part of penetration testing may be inconvenient or infeasible, particularly in deployment environments that are restricted for security or operational reasons.

Techniques for monitoring and replicating deployment environments of AI applications for more convenient security testing are disclosed herein. A testing environment provisioning service (“service”) obtains configuration information for a deployment environment of an AI application based on monitoring the deployment environment to determine an initial configuration thereof. The deployment environment of an AI application refers to the deployed instance of the AI application, AI-related components leveraged by the AI application, and other components in the line of network traffic of the AI application. Examples of components in the line of network traffic of the AI application that may be sources of configuration information include a Layer 7 firewall that inspects Layer 7 traffic of the AI application, an application programming interface (API) gateway deployed for the AI application, and/or a cloud logging service offered by a cloud provider that manages cloud infrastructure of the AI application. Configuration information obtained by the service from these sources that is included in the initial configuration includes configuration information for the language model(s) used by the AI application, such as type, version, and parameters of the language model(s), a prompt template(s) used by the AI application that the service reconstructs, and a configuration of a content filter used for monitoring prompts to and responses from the language model(s) (if any).

The service then monitors the deployment environment for any changes to the initial configuration, such as changes in language model type and/or configuration, by periodically obtaining additional configuration information for the deployment environment. When a substantial change to the initial configuration is detected from the additional configuration information, the testing service updates the initial configuration accordingly and provisions a testing environment with a language model(s) and any content filter configured according to the updated configuration. Security testing of the AI-related components for the AI application can then be initiated in the testing environment, with testing leveraging prompts created usings the prompt template(s) reconstructed by the service. Monitoring of the deployment environment for further changes in configuration of the components therein continues so that accurate and current configuration information for the deployment environment is readily available for subsequent security testing.

### EXAMPLE ILLUSTRATIONS

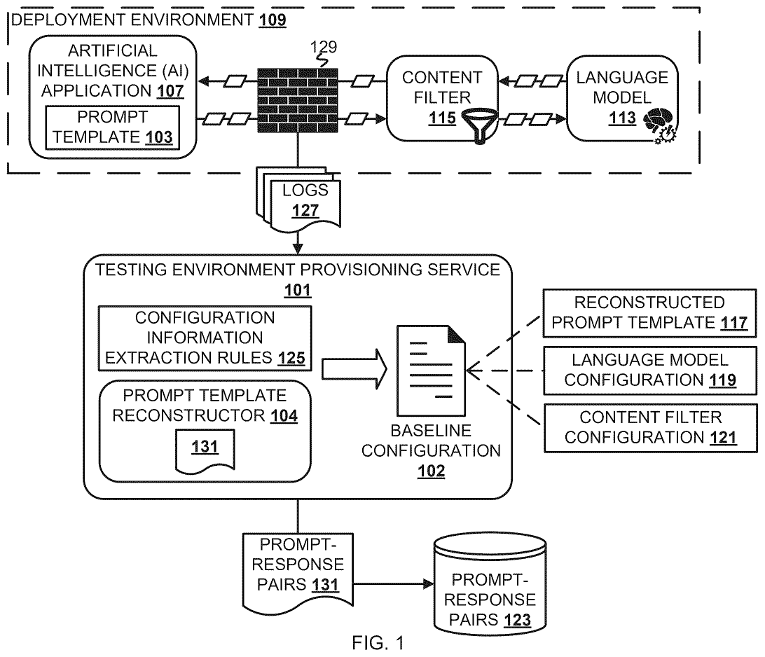

FIG. 1 is a conceptual diagram of generating a baseline configuration for a deployment environment of an AI application. A deployment environment 109 of an AI application 107 comprises the AI application 107 and a plurality of components/entities that interact with and/or support deployment of the AI application 107. This example depicts the deployment environment 109 as comprising a Layer 7 firewall (“firewall”) 129, a content filter 115, and a language model 113. The AI application 107 interfaces with the language model 113, which may be a pre-trained LLM. The deployment environment 109 can encompass other components/entities, such as other network components and/or cybersecurity components, that are omitted from this example for simplicity.

The AI application 107 is configured with a prompt template 103 based on which it generates prompts to the language model 113. The content filter 115 inspects prompts to and responses from the language model 113 based on guardrails configured to prevent misuse of the language model 113 by users of the AI application 107, such as by blocking prompts determined to include potentially harmful content. The content filter 115 can be an open-source and/or third-party, publicly available content filter leveraged by a provider of the AI application 107. The firewall 129 is deployed to inspect Layer 7 traffic sent to and from the AI application 107, which includes Layer 7 traffic corresponding to prompts to and responses from the language model 113 (subject to inspection and filtering by the content filter 115).

FIG. 1 also depicts a testing environment provisioning service (“service”) 101. The service 101 monitors the deployment environment 109 to determine a baseline configuration thereof. As will be described below, the baseline configuration comprises configuration information about the components/entities within the deployment environment 109 that support AI functionality of the AI application. In this example, these components/entities include the AI application 107, the content filter 115, the language model 113, and the prompt template 103.

The service 101 obtains logs 127 from the firewall 129. The service 101 can query log storage of the firewall 129 for log data corresponding to a designated time period, such as log data captured for a one-hour period. FIG. 1 depicts the service 101 as obtaining logs from the firewall 129 for simplicity, though implementations can leverage logs obtained from other sources in a deployment environment. The logs 127 indicate application layer/Layer 7 traffic captured for the AI application 107, such as Hypertext Transfer Protocol (HTTP) traffic sent to and from the AI application 107.

The service 101 determines configuration information for the AI application 107, content filter 115, and language model 113 based on the logs 127 and configuration information extraction rules (“rules”) 125. The rules 125 comprise rules for extracting configuration information from logs of various sources within a deployment environment being monitored, such as the deployment environment 109 in this example. For instance, the rules 125 can indicate a plurality of potential configuration information sources and, for each configuration information source, one or more data fields that store configuration information of interest, one or more patterns (e.g., regular expressions) that match to configuration information of interest, etc. The data field(s) and/or pattern(s) for each configuration information source have been previously determined based on expert knowledge and/or experimentation. For instance, the rules 125 defined for a Layer 7 firewall such as the firewall 129 can indicate one or more HTTP header fields from which to extract data/metadata, data from an application layer message to extract (e.g., based on matching of messages to one or more patterns, such as regular expressions), etc.

Configuration information to extract indicated by the rules 125 includes configuration information associated with the content filter 115 (e.g., guardrails with which the content filter 115 is configured), configuration information associated with the language model 113 (e.g., language model type and version, parameters, etc.), and a prompt template with which the AI application 107 has been configured (depicted in FIG. 1 as prompt template 103). Extraction of configuration information can include copying configuration information identified from logs or can include a more complex determination of configuration information based on identified log data. To illustrate, the service 101 can extract configuration information associated with the language model 113 by copying data/metadata stored in one or more data fields of the logs 127 as indicated in the rules 125 and can extract a prompt template from the logs 127 by identifying prompts to and responses from the language model 113 in the logs 127 and reconstructing the prompt template 103 therefrom. Generally, the rules 125 will at least indicate fields of log data pertaining to configuration information that the service 101 parses to identify the configuration information included therein.

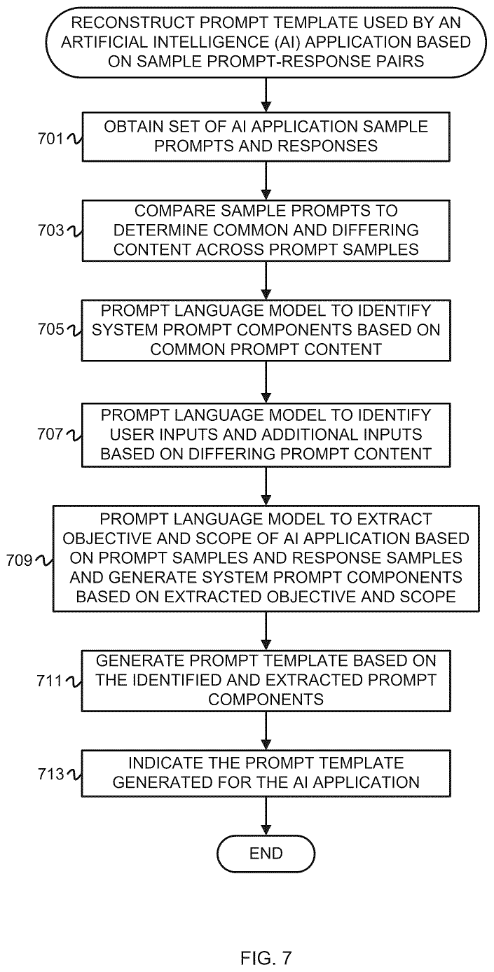

The service 101 also extracts pairs of prompts and responses submitted to the language model 113 from the logs 127. For instance, the rules 125 can comprise respective rules for extracting text identified in logs captured by a Layer 7 firewall that corresponds to a prompt to or response from a language model (e.g., based on matching contents of logged message bodies to respective one of a set of patterns indicated in the rules 125). Prompt-response pairs 131 comprise pairs of prompts submitted to the language model 113 and corresponding responses generated by the language model 113 and extracted from the logs 127. The service 101 comprises a prompt template reconstructor 104 that reconstructs the prompt template 103 to generate a reconstructed prompt template 117 based on the prompt-response pairs 131. To generate the reconstructed prompt template 117, the prompt template reconstructor 104 determines content that is common among prompts in the prompt-response pairs 131 and the content that differs among the prompts and generates a prompt template based on the identified common parts. Reconstruction of a prompt template from prompt-response pairs obtained for an AI application is described in further detail in reference to FIG. 7.

The service 101 stores the prompt-response pairs 131 extracted from the logs 127 in a database 123 of prompt/response pairs. Prompts from which a prompt template was reconstructed and their corresponding responses can later be leveraged to validate a testing environment provisioned by the service 101 as will be described in further detail below. Additionally, while the prompt template reconstructor 104 is depicted as executing as part of the service 101 in this example, the prompt template reconstructor 104 can execute external to the service 101 and be invoked for prompt template reconstruction. In this case, the prompt template reconstructor 104 reads the prompt-response pairs 131 from the database 123 and generates the reconstructed prompt template 117 to the service 101, with which the service 101 updates the baseline configuration 102.

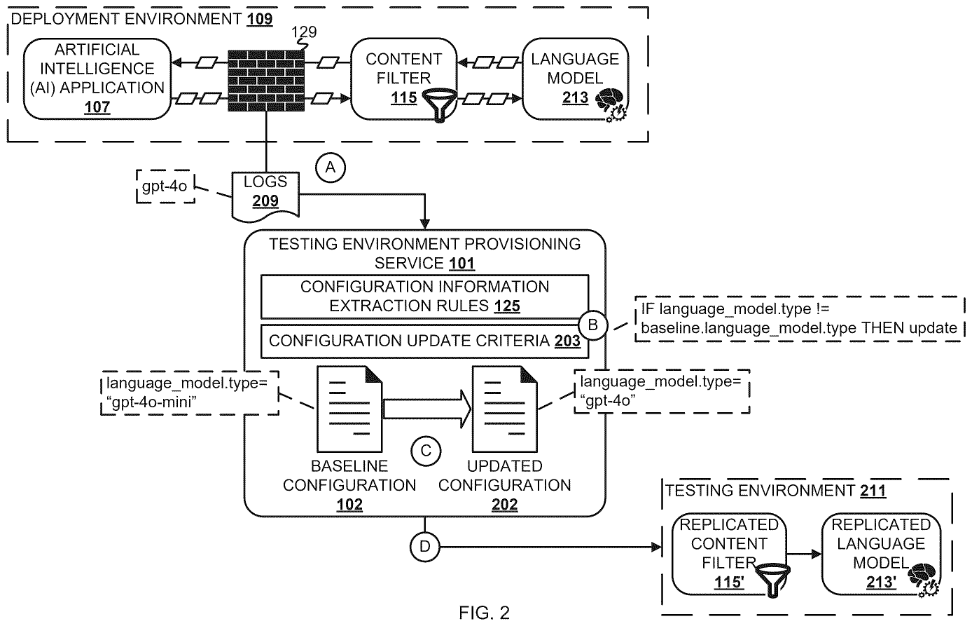

The service 101 populates a baseline configuration 102 with configuration information extracted from the logs 127 according to the rules 125. The baseline configuration 102 comprises a content filter configuration 121, a language model configuration 119, and the reconstructed prompt template 117. The content filter configuration 121 comprises the configuration information extracted from the logs 127 that corresponds to the content filter 115. The language model configuration 119 comprises the configuration information extracted from the logs 127 corresponding to the language model 113. The baseline configuration 102 can be implemented with a data structure(s), with a file, etc. in which the service 101 stores/writes configuration information. The service 101 continues monitoring the deployment environment 109 for changes that deviate from the baseline configuration 102 as is now described in reference to FIG. 2.

FIG. 2 is a conceptual diagram of provisioning a testing environment for security testing for an AI application based on detecting a change to a baseline configuration of a deployment environment of the AI application. FIG. 2 depicts the service 101 and the baseline configuration 102 of the deployment environment 109 described in reference to FIG. 1. This example assumes that the AI application 107 and content filter 115 remain unchanged in the deployment environment 109 since the service 101 generated the baseline configuration 102. However, in this example, the AI application 107 now interfaces with a language model 213; in other words, a new language model instance has replaced the language model 113 of FIG. 1. For instance, the language model 113 may have been updated to a new or different version, where the language model 213 corresponds to the new/different version, replaced with a different type of language model, or reconfigured with one or more different parameters.

FIG. 2 is annotated with a series of letters A-D, with each letter corresponding to a stage of one or more operations. Although these stages are ordered for this example, the stages illustrate one example to aid in understanding this disclosure and should not be used to limit the claims. Subject matter falling within the scope of the claims can vary from what is illustrated.

At stage A, the service 101 retrieves logs 209 from the deployment environment 109. Log retrieval after generation of the baseline configuration 102 can be performed periodically (e.g., every hour, every six hours, etc.) or according to a schedule. As in FIG. 1, the logs 209 comprise log data captured by the firewall 129. This example assumes that the logs 209 indicate that the language model 213 is the GPT-40™ model.

At stage B, the service 101 extracts configuration information from the logs 209 and determines if any configuration update criteria (“criteria”) 203 are satisfied. The service 101 extracts configuration information from the logs 209 according to the rules 125 as similarly described in reference to FIG. 1. Extracted configuration information includes configuration information of the content filter 115, configuration information of the language model 213, and a prompt template with which the AI application 107 is configured. The service 101 evaluates the extracted configuration information in comparison to the baseline configuration 102 based on the criteria 203 to determine if the configuration of any components/entities in the deployment environment 109 has substantially changed from the baseline configuration 102. The criteria 203 can indicate one or more configuration fields of the baseline configuration 102 that, if a difference is identified from the value stored in the baseline configuration 102 and the corresponding value extracted from the logs 209, trigger testing environment provisioning. Examples of configuration fields indicated in the criteria 203 that are monitored for changes include language model type, language model version, one or more language model parameters, unsafe content categories designated for a content filter, etc. The criteria 203 can also indicate a threshold for differences between the prompt template indicated in the baseline configuration 102 and a prompt template reconstructed based on the logs 209, where a difference in contents exceeding the threshold (e.g., more than 10% difference in contents) is considered substantial and triggers updating the configuration and provisioning a testing environment.

If configuration information pertaining to the content filter 115 or the language model 213 of a same type but with different values is identified from the logs 209, the service 101 can leverage the configuration information with a later timestamp for evaluation based on the criteria 203. A difference can be reflective of a change or update occurring within the time window to which the logs 209 correspond. To illustrate, if first log data with an earlier timestamp indicates a first language model type and second log data with a later timestamp indicates a second language model type for the same language model endpoint (e.g., for the same API endpoint), the service 101 compares the second, more current language model type to the language model type indicated in the baseline configuration 102 rather than the earlier, first language model type for evaluation based on the criteria 203.

In this example, the baseline configuration 102 indicates a language model type of the GPT-4o mini model. This language model type corresponds to the language model 113 of FIG. 1. However, the language model type identified in the logs 209 as described above is the GPT-4o model. The criteria 203 include an example criterion indicating that if the language model type identified from monitoring the deployment environment 109 changes from that indicated in the baseline configuration 102, then a configuration update should be triggered. The service 101 determines that this criterion is satisfied since the language model in the deployment environment 109 has changed since the baseline configuration 102 was generated.

At stage C, the service 101 updates the baseline configuration 102 to generate an updated configuration 202. The service 101 updates the language model type indicated in the baseline configuration 102 to reflect the currently deployed language model type. As a result, the updated configuration 202 indicates the type of language model currently deployed as reflected in the logs 209.

At stage D, the service 101 provisions a testing environment 211 based on the updated configuration 202. The testing environment 211 is a computing environment provisioned for testing of the AI-related components leveraged by the AI application 107, which in this example is the content filter 115 and the language model 213. The testing environment 211 can comprise virtual/cloud infrastructure that is not necessarily managed by the same entity as the AI application. For instance, the testing environment 211 can comprise infrastructure managed by the provider of the content filter 115 and/or the language model 213 that the service 101 can access via an API endpoint.

The service 101 deploys a replicated content filter 115′ and a replicated language model 213′ to the testing environment 211. The replicated content filter 115′ and the replicated language model 213′ are configured as replicas of the content filter 115 and the language model 213, respectively. To do so, the service 101 configures the replicated content filter 115′ according to the configuration information maintained in the updated configuration 202 for the content filter 115 and configures the replicated language model 213′ according to the configuration information maintained in the updated configuration 202 for the language model 213. The testing environment 211 thus replicates the AI-related components of the deployment environment 109 to provide offline security testing that does not impact or interfere with the deployment environment 109 itself.

For security testing, testing personnel and/or a testing service (e.g., a red-teaming testing service) leverages the prompt template 103 reconstructed for the AI application 107 described in reference to FIG. 1 and constructs various prompts that are submitted to the replicated language model 213′ and subject to content filtering by the replicated content filter 115′. Responses to the prompts can be obtained and evaluated to determine whether the replicated content filter 115′ and replicated language model 213′ (and thus the content filter 115 and the language model 213) are vulnerable to attacks or security risks such as prompt injection or jailbreaking attacks. Results of testing that are generated are thus applicable to the current configuration of the deployment environment 109.

FIGS. 1 and 2 depict the deployment environment 109 as comprising a Layer 7 firewall and a single content filter and language model for clarity and to aid in understanding, though implementations can apply to more complex deployment environments. For instance, deployment environments monitored by the service 101 can include multiple language models with which an AI application interfaces according to one or more multiple respective prompt templates. Additionally, the AI application 107 can be configured with multiple prompt templates used to construct prompts to a single language model (and optionally a respective content filter) or can be configured with one prompt template used to construct prompts submitted to multiple different language models (and optionally respective content filters). As another example, monitored deployment environments can include other components/entities from which the service 101 obtains logs, such as an API gateway and/or cloud storage managed by a cloud service provider that manages cloud infrastructure that supports deployment of the AI application 107.

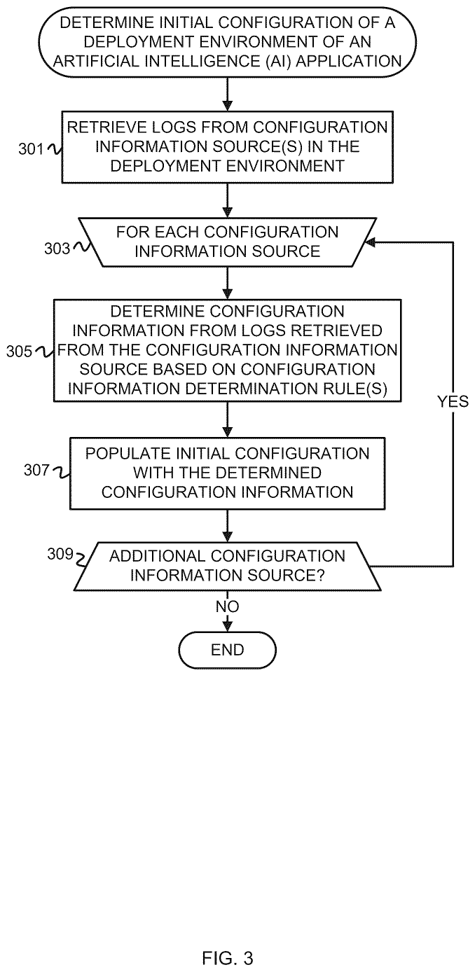

FIGS. 3-7 are flowcharts of example operations. The example operations are described with reference to a testing environment provisioning service (hereinafter “the service”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for determining an initial configuration of a deployment environment of an AI application. The deployment environment at least includes the AI application and a language model to which the AI application submits prompts. Deployment environments can include multiple language models and other AI-related components/entities, such as a content filter(s) that moderates content sent to and from the language model(s). Determination of the initial configuration can be initiated based on satisfaction of a triggering condition, such as following initial deployment of the AI application, receipt of a request to begin deployment environment monitoring for the AI application, etc.

At block 301, the service retrieves logs from one or more configuration sources in the deployment environment. A configuration information source is a component or entity that collects and/or maintains data/metadata (e.g., log data) from which the service can identify configuration information for the deployment environment. Examples of configuration information sources for a deployment environment include API gateways, Layer 7 firewalls, and cloud logging services, as well as log storage thereof. The types of configuration information sources from which the service obtains configuration information can vary among implementations. The service is configured with indications of one or more configuration information sources for the deployment environment. For instance, the service can be configured with an indication of an API endpoint, a network address, a location in storage, etc. for each configuration information source. The service retrieves the logs from each indicated configuration information source (e.g., via an API function call, submission of a request, etc.).

At block 303, the service begins iterating over each configuration information source. Determination of configuration information from logs can be dependent on the type of configuration information source, as logs retrieved from different configuration information sources can include different types of configuration information, have different formats or schemas, etc. Iteration can be over logs retrieved from each individual configuration information source or over logs retrieved from each configuration information source of a same type (e.g., logs retrieved from each of multiple Layer 7 firewalls in the deployment environment).

At block 305, the service determines configuration information from the logs obtained from the configuration information source based on a corresponding configuration information determination rule(s). The service has been configured with a set of rules for determining configuration information from logs that are at least partly dependent on the component/entity from which the logs originated. Multiple sets of rules for configuration information sources of a same type but with different providers/managing entities (e.g., different cloud providers) can be further defined, such as multiple sets of rules corresponding to cloud logging services offered by different respective cloud providers. The rules indicate, for each configuration information source (e.g., each of API gateway, Layer 7 firewall, and/or cloud logging service), one or more data/metadata fields that store configuration information and/or one or more patterns (e.g., regular expressions) that match to contents of the logs that correspond to configuration information. The service determines the configuration information by copying log data stored in each field indicated by the rule(s), copying contents of the logs that matched to a pattern(s) indicated by the rule(s), etc. The rules can also indicate a rule(s) for identifying prompts and responses to be extracted from the logs from which a prompt template can be reconstructed, as some types of configuration information sources can log prompts and responses. In this case, the service extracts the prompts and responses and generates a prompt template based on the extracted prompts and responses, where the prompt template is regarded as configuration information associated with the AI application. Prompt template determination can be performed as further described in reference to FIG. 7.

At block 307, the service populates the initial configuration with the extracted configuration information. The initial configuration can be maintained in a file(s), data structure(s), etc. in which the service stores the determined configuration information. The data field(s), element(s), of the initial configuration etc. in which the service stores the determined configuration information is dependent on the rule(s) satisfied for configuration information determination. To illustrate, if the service identified a language model type and version from the logs based on satisfaction of a configuration information rule(s) for language model type and version determination, the service stores an indication of the language model type and version in respective fields or elements of the initial configuration.

At block 309, the service determines if an additional configuration information source is remaining. If an additional configuration information source is remaining, operations continue at block 303. If not, and logs from each configuration information source have been processed, operations are complete. The initial configuration is thus populated to reflect an initial state of the deployment environment.

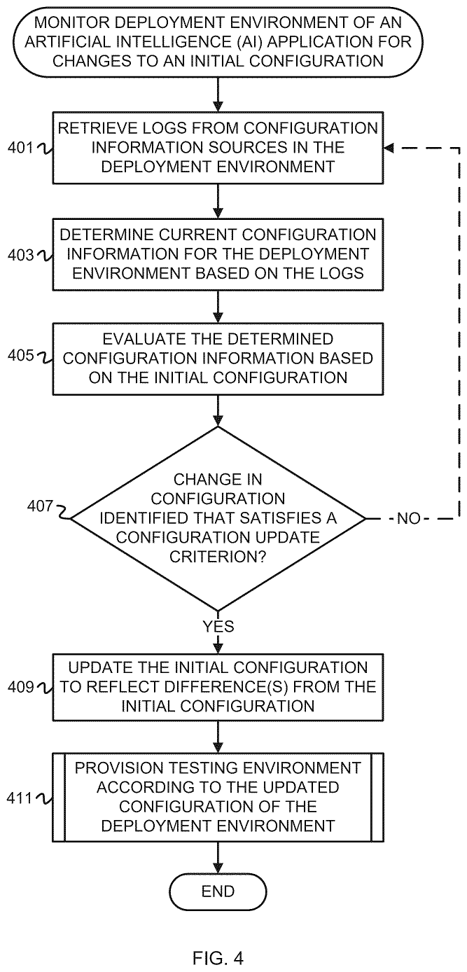

FIG. 4 is a flowchart of example operations for monitoring a deployment environment of an AI application for changes to an initial configuration. As similarly described in reference to FIG. 3, the deployment environment at least includes the AI application and a language model to which the AI application submits prompts. Deployment environments can include multiple language models and other AI-related components/entities, such as a content filter(s) that moderates content sent to and from the language model(s).

At block 401, the service retrieves logs from one or more configuration information sources in the deployment environment. Log retrieval can be performed according to a schedule (e.g., hourly) or based on satisfaction of a triggering condition, such as receipt of a request to initiate configuration change detection. The service can query log storage for each configuration information source for log data captured during a designated time period (e.g., the last hour). Examples of configuration information sources include a Layer 7 firewall that inspects application layer network traffic of the AI application, particularly network traffic destined for and originating from the language model in the deployment environment, an API gateway that routes requests to the AI application, and a logging service offered by a cloud provider that manages cloud infrastructure that supports deployment of the AI application.

At block 403, the service determines current configuration information for the deployment environment based on the logs. The service extracts the configuration information from the logs as similarly described in reference to FIG. 3. The extracted configuration information reflects the current configuration information for the deployment environment (e.g., a currently deployed language model and version, a current prompt template(s) with which the AI application is configured, etc.).

At block 405, the service evaluates the determined configuration information based on the initial configuration. The service compares the current configuration information to the initial configuration to determine if any aspects of the configuration have changed from the initial configuration. Examples of configuration aspects that may change from the initial configuration include a change in the type and/or version of language model(s) with which the AI application interfaces, changes to one or more parameters of the language model, a change in configuration of the content filter(s) deployed to interface with the language model(s) (e.g., an update to the guardrails with which the content filter is configured, such as a change in categories of unsafe content and/or a change to regular expressions with which the content filter is configured), if any, and/or a change to the prompt template(s) used by the AI application for prompting the language model(s).

At block 407, the service determines if there has been a change in the configuration that satisfies a configuration update criterion. The service is configured with configuration update criteria that, if satisfied, trigger detection of a substantial change from the initial configuration. Examples of changes that may satisfy a respective one of the configuration update criteria include changes to the language model type and/or version, a substantial change to one or more parameters of the language model (e.g., a difference between a parameter indicated in the initial configuration and a current parameter exceeding a threshold), and a substantial change to the prompt template (e.g., a difference in contents of the current prompt template from contents of the initial prompt template that exceeds a threshold). Changes in the current prompt template from the initial prompt template can be detected via a diff algorithm. If there is a change in the configuration that satisfies at least a first of the configuration update criteria, operations continue at block 409. If not, operations continue at block 401. The transition from block 407 to block 401 is depicted in dashed lines to indicate that the next log retrieval event can occur at a subsequent time after continued monitoring of the deployment environment, such as according to a later-scheduled log retrieval event.

At block 409, the service updates the initial configuration to reflect the difference(s) from the initial configuration. The difference(s) from the initial configuration are the changes from the initial configuration identified in the current configuration information identified at block 407. The service updates the initial configuration with the determined difference(s) to generate an updated configuration that reflects the current configuration of the deployment environment (e.g., the current language model type and/or version, the current prompt template, etc.).

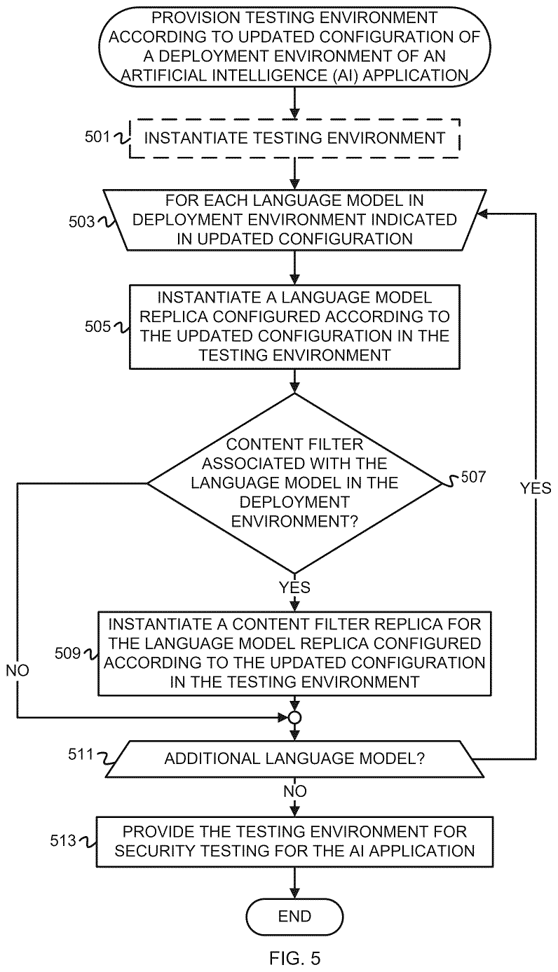

At block 411, the service provisions a testing environment according to the updated configuration of the deployment environment. The service instantiates one or more components/entities in a testing environment that are replicas of their counterparts in the deployment environment. In other words, each component/entity is instantiated and configured according to the corresponding configuration information in the updated configuration. The component(s)/entity(ies) that the service instantiated in the testing environment are those that leverage, support, or otherwise relate to AI functionality of the AI application. This will generally at least include a language model but can also include multiple language models and/or a content filter(s). The testing environment is then made available for security testing the AI-related components/entities in the deployment environment of the AI application, which provides for detection of prompt injection and/or jailbreaking attacks impacting the AI application. Provisioning of the testing environment is described in further detail in reference to FIG. 5.

FIG. 5 is a flowchart of example operations for provisioning a testing environment according to an updated configuration of a deployment environment of an AI application. The example operations assume that the AI application interfaces with at least a first language model, and a content filter may be configured for the language model. Generally, AI applications will leverage publicly-available and/or open-source language models and content filters. The service can thus instantiate replica versions of the language model(s) and any content filter(s) for security testing purposes, where the replica versions have a same type/version and configuration as the corresponding language model or content filter in the deployment environment.

At block 501, the service instantiates a testing environment. Instantiating the testing environment can include instantiating a computing environment, such as a virtual environment or cloud environment, in which a language model(s) and content filter(s) can be deployed. As another example, instantiating the testing environment can include configuring an API endpoint for the testing environment. Block 501 is depicted in dashed lines to indicate that this operation can be optional and/or can vary among deployment mechanisms offered by language model providers. For instance, implementations can privately host model instances for testing in a virtual/cloud environment. In other examples, implementations can leverage infrastructure made available by language model providers and configure a private endpoint for accessing the infrastructure. In any case, as used herein, the “testing environment” encompasses the AI-related components to which prompts are submitted as part of security testing (e.g., penetration testing and/or red-teaming).

At block 503, the service begins iterating over each language model in the deployment environment indicated in the updated configuration. Each language model is associated with at least one prompt template and may also be associated with a content filter. Deployment environments can include multiple language models, each of which has a respective prompt template(s) and optionally a content filter.

At block 505, the service instantiates a language model replica configured according to the updated configuration in the testing environment. The service instantiates a language model replica in the testing environment, where the language model is of the type and version and configured with the parameters indicated in the updated configuration. For instance, the service can orchestrate deployment of the language model replica via a command line interface (CLI) or API offered by a provider of the language model.

At block 507, the service determines if a content filter is associated with the language model in the deployment environment. The updated configuration can also comprise a configuration of a content filter that moderates content for the language model determined from monitoring of the deployment environment. If a content filter is associated with the language model in the deployment environment, operations continue at block 509. If not, operations continue at block 511.

At block 509, the service instantiates a content filter replica for the language model replica configured according to the updated configuration in the testing environment. The service instantiates a content filter of the type/version indicated in the updated configuration and that is configured with the same guardrails, rules, etc. indicated therein. The language model replica and content filter to be replicated may be offered by the same provider. In such cases, the service can indicate the language model for which the content filter replica should be deployed, or the language model replica, in the configuration of the language model replica. In other cases, a content filter offered by a different provider may be leveraged for moderating content of the language model in the deployment environment. In such cases, the service can connect the content filter replica to the language model replica by indicating the language model replica in the configuration of the content filter replica (e.g., with an API endpoint of the language model replica).

At block 511, the service determines if there is an additional language model indicated in the updated configuration. If so, operations continue at block 503. Otherwise, operations continue at block 513.

At block 513, the service provides the testing environment for security testing for the AI application. Security testing of the AI application serves to identify jailbreaking attacks, prompt injection, or other security issues with the AI-related components leveraged by the AI application (i.e., the language model(s) and any content filter(s)) that may be presenting security concerns for the AI application. A red-teaming service may be provided access to the testing environment to perform security testing.

During security testing, the prompt template reconstructed for the AI application is leveraged to construct malicious prompts to the language model to evaluate responses to the malicious prompts. Vulnerabilities of the language model and/or insecure content filter configurations can thus be identified as a result of security testing. During testing leveraging the testing environment, each combination of prompt template, language model, and any content filter can be tested separately in cases where multiple language models and respective content filters are provisioned and/or the AI application is configured with multiple prompt templates. To illustrate, if the testing environment comprises a single language model and content filter but multiple prompt templates were reconstructed, prompts constructed according to each prompt template can be constructed for testing of the language model and content filter separately between each set of prompts corresponding to the prompt templates. If the testing environment comprises multiple language models and respective content filters but a single prompt template was reconstructed, each language model and content filter pair can be tested individually using prompts reconstructed using the prompt template.

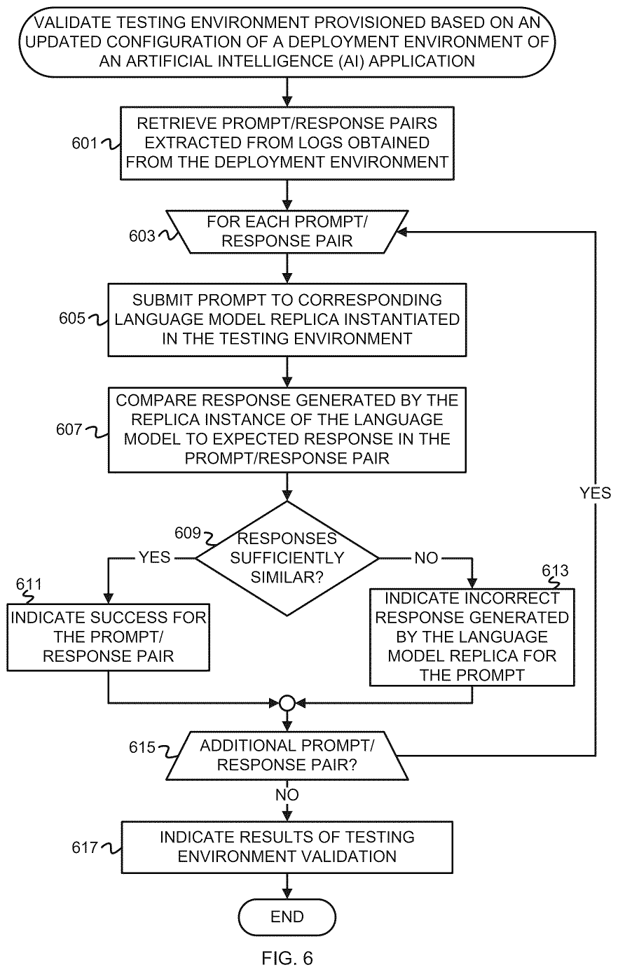

FIG. 6 is a flowchart of example operations for validating a testing environment provisioned based on an updated configuration of a deployment environment of an AI application. Since prompts to a language model and response were collected as part of reconstructing a prompt template used by the AI application for the purpose of detecting changes to the initial prompt template described above, the service can also use the collected prompts and responses to validate the testing environment to ensure that the language model(s) and any content filter(s) were configured to correctly replicate their counterparts in the deployment environment.

At block 601, the service retrieves a plurality of prompt/response pairs extracted from logs obtained from the deployment environment. The service has previously stored the prompt/response pairs as part of reconstructing the prompt template and monitoring for changes thereto. At block 603, the service begins iterating over each prompt/response pair.

At block 605, the service submits the prompt to the corresponding language model replica instantiated in the testing environment. The service submits the prompt to the language model replica, or the language model instance deployed in the testing environment that is configured to replicate the corresponding language model in the deployment environment.

At block 607, the service compares a response generated by language model replica to the expected response in the prompt/response pair. The service compares the response obtained from the language model replica to the expected response generated in the deployment environment by the language model being replicated to identify any substantial differences therebetween. For instance, the service can determine a diff between the generated and expected responses. As another example, the service can prompt a different language model to evaluate the responses for similarity, such as whether the responses are semantically similar.

At block 609, the service determines if the responses are sufficiently similar. Responses may be sufficiently similar if they have a same meaning based on semantic similarity evaluation and/or based on syntactic similarity, with minor differences in syntax permitted. If the responses are sufficiently similar, operations continue at block 611. If not, operations continue at block 613.

At block 611, the service indicates success for the prompt/response pair. A success for the prompt/response pair indicates that the language model replica (and any content filter replica deployed to moderate content sent to and from the language model replica) is behaving as expected relative to the language model in the deployment environment being replicated. The service can send a notification indicating the success, update a report generated from validation with an indication of the success, etc.

At block 613, the service indicates that the language model replica generated an incorrect response for the prompt. Generation of an incorrect response, or a response that substantially differed from the expected response in the prompt/response pair, is indicative of an inconsistency in configuration of the language model replica relative to the corresponding language model in the deployment environment. Configuration information based on which the language model replica was configured may thus be incorrect and/or incomplete. The service indicates that the prompt/response pair yielded an incorrect response from the language model replica, such as by generating notification, updating a report, etc. The indication can include the expected response and the language model replica-generated response.

At block 617, the service indicates results of testing environment validation. The service can generate a notification, indicate (e.g., present on a user interface and/or store in a database) a report indicating the validation results, etc. If the results indicate multiple (e.g., a number exceeding a threshold) inconsistencies between expected responses and language model replica-generated responses, the service can indicate that the language model replica and/or content filter replica should be investigated further to identify any errors in configuration that substantially deviate from that of the language model and/or content filter being replicated.

FIG. 6 assumes a deployment environment comprising one language model and one prompt template used for generating prompts thereto, though the example operations can be performed for each language model and/or for each set of prompts and responses corresponding to a prompt template for deployment environments with multiple language models and/or AI application figurations with multiple prompt templates.

FIG. 7 is a flowchart of example operations for reconstructing a prompt template used by an AI application based on sample prompt-response pairs. The example operations assume that a dataset of benign prompts have been provided or identified as well as the corresponding responses. The benign prompts and responses are used as samples for learning system prompt components.

At block 701, the service obtains a set of AI application sample prompts and responses. The service can read from a database of prompt and response samples extracted from logs obtained from a deployment environment as described above.

At block 703, the service compares the sample prompts to determine common and differing content. The service performs pairwise comparisons across the prompts. The service can use a diff tool for each comparison to eventually identify content that is common across all of the prompt samples. If an AI application uses a multimodal language model, then the service can pre-process multimodal prompts to disregard non-text content in a prompt and designate non-text content as differing content. Instead of pre-processing prompt samples, the service can separate the text content of the prompt sample from the non-text content in each comparison. The service can then compare the text content and indicate the non-text content as different content. Implementations can vary in how to determine content that is common across the prompt samples. For instance, common content for pairwise comparisons can be used in each successive comparison until the remaining common content is common across all prompt samples. As another example, common content can be compared between prompts and then among comparisons in a hierarchical manner.

At block 705, the service tool prompts a language model to identify system prompt components based on the common content. The language model being prompted differs from the language model(s) in the deployment environment of the AI application. The prompt can direct the model with the task of identifying system prompt components and then provide context with examples of types of prompt components (e.g., formatting instructions, role assignment, few-shot examples, task instructions, etc.). For example, the service constructs a prompt with the task instruction to identify system prompt components in the content that will be inserted, with a listing of the different types of prompt components, and the common content.

At block 707, the service prompts the language model to identify user inputs and additional input components based on the differing content. The service constructs a prompt with a task instruction to identify user input and additional input from the differing content and with the differing content inserted. The service can include, in the prompt, hints or content specifying examples of user input as queries, files, or messages and examples of additional input as context or supplemental information likely added by the application based on configuration or programming of owners or developers of an AI application. The service can also include context in the prompt that provides examples of additional input, such as user profiles, conversation history, or domain specific documents from a retrieval-augmented generation (RAG) database. The service can interact with the language model with multiple prompts depending upon the number of prompt samples and token window size of the language model.

At block 709, the service prompts the language model to extract the objective and scope of the AI application based on the prompt samples and the response samples and to generate system prompt components based on extracted objective and scope. The objective of an AI application is the purpose the AI application is attempting to fulfill. For example, an objective could be, “Act as a hiring manager and evaluate potential employees to determine job compatibility.” Instructing the language model to extract an objective and generate a prompt system component from the objective can yield a role and responsibilities that provide context for task instructions. The scope of an AI application corresponds to limits of responses that can be generated by the language model used by the AI application. If objective and scope cannot be determined from prompt samples, the service can extract objective and scope from the response samples. If objective and scope can be determined from the response samples, then the service can prompt the language model to refine the objective and scope extracted from the prompt samples based on the response samples. In the prompt to the language model, the service can include task instructions to extract from prompt samples requirements or constraints that correspond to scope of the application and to refine any extracted constraints and requirements based on the sample responses. For example, the service constructs a prompt to extract the objective and scope with task instructions to determine the AI role, responsibilities, and requirements based on the objective and scope extracted from the prompt samples and refine the objective and scope based on the response samples.

At block 711, the service generates a prompt template based on the identified and extracted prompt components. For instance, the service can be configured with or can have access to an application agnostic prompt template that it updates to generate the prompt template for the AI application. The service iterates through the identified or extracted system prompt components and populates a prompt template (e.g., the application agnostic prompt template) based on the identified and extracted prompt components. The service can also insert placeholders for user input and additional input components into the prompt template.

At block 713, the service indicates the prompt template generated for the AI application. For instance, the service can update a baseline configuration generated for the deployment environment with the generated prompt template. As another example, the service can indicate the generated prompt template for comparison with the prompt template indicated in the baseline configuration to determine if the prompt template has substantially changed to trigger provisioning of a testing environment.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

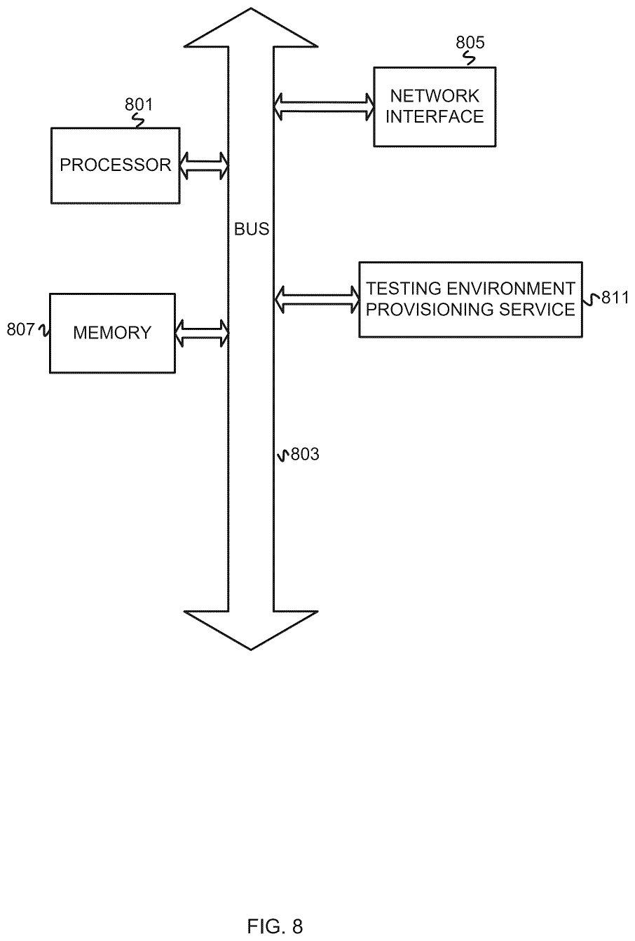

FIG. 8 depicts an example computer system with a testing environment provisioning service. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes testing environment provisioning service 811. The testing environment provisioning service 811 monitors a deployment environment of an application that interfaces with a language model(s) to determine an initial configuration of the deployment environment (e.g., a configuration of the language model(s) a configuration of a content filter(s) that interfaces with the language model(s), if any, etc.). The testing environment provisioning service 811 continues monitoring the deployment environment to detect deviations from the baseline configuration and, if a deviation from the baseline configuration is detected, updates the initial configuration to reflect the deviation and provisions a testing environment based on the updated configuration. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
determining a baseline configuration for a deployment environment of an artificial intelligence (AI) application that interfaces with a language model based on monitoring deployment of the AI application, wherein the baseline configuration comprises configuration information obtained for the language model and the AI application;
based on ongoing monitoring of deployment of the AI application, detecting a change to the baseline configuration that satisfies a criterion for updating the baseline configuration;
updating the baseline configuration based on the detected change;
provisioning a testing environment based on the updated baseline configuration, wherein provisioning the testing environment comprises provisioning a replica instance of the language model; and
providing the testing environment for security testing.

2. The method of claim 1, further comprising indicating results of security testing in the testing environment, wherein the results of the security testing indicate whether at least one of prompt injection and a jailbreaking attack was detected for the AI application.

3. The method of claim 1, wherein determining the baseline configuration comprises determining at least one of a type of the language model, a version of the language model, parameters of the language model, a configuration of a content filter deployed for the language model, and a prompt template used by the AI application.

4. The method of claim 3, wherein the change to the baseline configuration that satisfies the criterion comprises at least one of a change to the at least one of the type and version of the language model, a change to one or more of the parameters of the language model, a change to the configuration of the content filter, and a change to contents of the prompt template that exceeds a difference threshold.

5. The method of claim 1, wherein the ongoing monitoring of deployment of the AI application comprises,
periodically obtaining additional configuration information for the language model and the AI application; and
evaluating the additional configuration information based on the baseline configuration, wherein detecting the change to the baseline configuration that satisfies the criterion comprises determining that a difference between the additional configuration information and the baseline configuration satisfies the criterion.

6. The method of claim 1, further comprising validating the testing environment based on a plurality of prompts to the language model and a corresponding plurality of responses generated by the language model obtained from monitoring deployment of the AI application.

7. The method of claim 6, wherein validating the testing environment comprises,
prompting the replica instance of the language model with the plurality of prompts; and
evaluating responses to the plurality of prompts generated by the replica instance of the language model based on corresponding ones of the plurality of responses obtained from monitoring the deployment environment.

8. The method of claim 1, further comprising obtaining logs of at least one of a Layer 7 firewall, an application programming interface (API) gateway, and a logging service offered by a cloud service provider (CSP), wherein determining the baseline configuration comprises identifying the configuration information from the logs.

9. One or more non-transitory machine-readable media having program code stored thereon, the program code comprising instructions to:
determine an initial configuration of a deployment environment of an artificial intelligence (AI) application that interfaces with a first language model based on first configuration information obtained from monitoring deployment of the AI application;
detect a deviation from the initial configuration that satisfies a configuration update criterion based on continued monitoring of deployment of the AI application;
update the initial configuration based on the detected deviation to generate an updated configuration;
provision a testing environment based on the updated configuration, wherein the testing environment comprises a second language model configured according to configuration information of the updated configuration that corresponds to the first language model; and
indicate availability of the testing environment for security testing.

10. The non-transitory machine-readable media of claim 9, wherein the instructions to determine the initial configuration comprise instructions to determine at least one of a type and a version of the first language model, parameters of the first language model, a configuration of a content filter deployed for the first language model, and a prompt template used by the AI application.

11. The non-transitory machine-readable media of claim 10, wherein the instructions to detect the deviation from the initial configuration comprise instructions to detect at least one of a change to the type of the first language model, a change to the version of the first language model, a change to one or more of the parameters of the first language model, a change to the configuration of the content filter, and a substantial change to contents of the prompt template.

12. The non-transitory machine-readable media of claim 9, wherein the program code further comprises instructions to obtain logs from at least one of a Layer 7 firewall, an application programming interface (API) gateway, and a logging service offered by a cloud service provider (CSP), and wherein the instructions to determine the initial configuration comprise instructions to determine the initial configuration from the logs obtained from the at least one of the Layer 7 firewall, the API gateway, and the logging service offered by the CSP.

13. The non-transitory machine-readable media of claim 12, wherein the instructions for the continued monitoring of deployment of the AI application comprise instructions to periodically obtain additional logs from the at least one of the Layer 7 firewall, the API gateway, and the logging service, wherein the instructions to detect the deviation from the initial configuration that satisfies the configuration update criterion comprise instructions to compare second configuration information determined from the additional logs to the initial configuration and determine if a deviation in the second configuration information from the initial configuration satisfies the configuration update criterion.

14. The non-transitory machine-readable media of claim 9, wherein the program code further comprises instructions to validate the testing environment based on a plurality of prompts to the first language model and a corresponding plurality of responses generated by the first language model, wherein the plurality of prompts and the corresponding plurality of responses were obtained from monitoring deployment of the application.

15. An apparatus comprising:
a processor; and
a machine-readable medium having instructions stored thereon that are executable by the processor to cause the apparatus to,
determine a baseline configuration for a deployment environment of an application that interfaces with a language model based on monitoring the deployment environment, wherein the baseline configuration comprises configuration information obtained for the language model and the application;
based on ongoing monitoring of the deployment environment, detect a change to the baseline configuration that satisfies a criterion for updating the baseline configuration;
update the baseline configuration based on the detected change to generate an updated configuration;
provision a testing environment based on the updated configuration, wherein the testing environment comprises a replica instance of the language model configured according to the updated configuration; and
provide the testing environment for security testing.

16. The apparatus of claim 15, wherein the instructions executable by the processor to cause the apparatus to determine the baseline configuration comprise instructions executable by the processor to cause the apparatus to determine at least one of a type of the language model, a version of the language model, parameters of the language model, a configuration of a content filter deployed for the language model, and a prompt template used by the application.

17. The apparatus of claim 16, wherein the instructions executable by the processor to cause the apparatus to detect the change to the baseline configuration comprise instructions executable by the processor to cause the apparatus to detect at least one of a change to the type of the language model, a change to the version of the language model, a change to one or more of the parameters of the language model, a change to the configuration of the content filter, and a substantial change to contents of the prompt template.

18. The apparatus of claim 15, wherein the instructions executable by the processor to cause the apparatus to monitor the deployment environment comprise instructions executable by the processor to cause the apparatus to retrieve logs from at least one of a Layer 7 firewall, an application programming interface (API) gateway, and a logging service offered by a cloud service provider (CSP), and wherein the instructions executable by the processor to cause the apparatus to determine the baseline configuration comprise instructions executable by the processor to cause the apparatus to determine the baseline configuration based on configuration information identified in the logs.

19. The apparatus of claim 15, further comprising instructions executable by the processor to cause the apparatus to validate the testing environment based on a plurality of prompts to the language model and a corresponding plurality of responses generated by the language model, wherein the plurality of prompts and the corresponding plurality of responses were obtained from monitoring the deployment environment.

20. The apparatus of claim 19, wherein the instructions executable by the processor to cause the apparatus to validate the testing environment comprise instructions executable by the processor to cause the apparatus to,
prompt the replica instance of the language model with the plurality of prompts; and
evaluate responses to the plurality of prompts generated by the replica instance of the language model based on corresponding ones of the plurality of responses obtained from monitoring the deployment environment.
